(19) United States
(12) Patent Application Publication
(10) Pub. No.: US 2013/0275085 A1
(43) Pub. Date: Oct. 17, 2013

(54) PERFORMANCE MANAGEMENT AND QUANTITATIVE MODELING OF IT SERVICE PROCESSES USING MASHUP PATTERNS

(71) Applicants: Winnie Cheng, Tarrytown, NY (US); David Matthew Loewenstern, New York, NY (US); Louis John Percello, Armonk, NY (US); Carlos Raniery Paula dos Santos, Porto Alegre - RS (BR); Larisa Shwartz, Scarsdale, NY (US); Nikolaos Anerousis, Chappaqua, NY (US); Lisandro Zambenedetti Granville, Porto Alegre - RS (BR)

(72) Inventors: Winnie Cheng, Tarrytown, NY (US); David Matthew Loewenstern, New York, NY (US); Louis John Percello, Armonk, NY (US); Carlos Raniery Paula dos Santos, Porto Alegre - RS (BR); Larisa Shwartz, Scarsdale, NY (US); Nikolaos Anerousis, Chappaqua, NY (US); Lisandro Zambenedetti Granville, Porto Alegre - RS (BR)

(73) Assignees: FEDERAL UNIVERSITY OF RIO GRANDE DO SUL, Porto Alegre - RS (BR); INTERNATIONAL BUSINESS MACHINES CORPORATION, Armonk, NY (US)

(21) Appl. No.: 13/445,516

(22) Filed: Apr. 12, 2012

(51) Int. Cl. G06F 15/00

(52) U.S. Cl. 702/182

(57) ABSTRACT

Methods and arrangements for quantitatively modeling service processes. A process is assimilated, the process comprising at least one step. At least one quantitative metric with respect to the process is estimated, and at least one mashup pattern applicable to the process is determined, the at least one mashup pattern comprising at least one mashup pattern applicable to at least one process step. The determining includes recalculating the at least one quantitative metric in consideration of at least one mashup pattern and applying at least one mashup pattern to the process responsive to improvement in the at least one quantitative metric.

### BACKGROUND

Generally, IT Service Management (ITSM) encompasses the practices for managing information technology systems. A significant body of work in this field addresses the issue of quality, i.e., the frameworks, processes and metrics that measure effectiveness from the point of view of the receiver of such services.

In ITSM, a very large percentage of the work is performed by humans, rather than machines. Due to its unpredictable nature, human behavior and performance are much harder to model, and consequently, to optimize. Consider the example of a modern data network that receives packets at an entry point and needs to transfer them to a destination. The data packet in its path will be processed by a variety of system elements, each programmed to perform a specific task with a high amount of accuracy and predictability. The number of events (exceptions) that can interrupt a normal processing path can be large, but are always finite, and in many cases can be accounted for in the design itself through redundancy and error handling programs.

By contrast, consider a service management operation organized according to the Information Technology Infrastructure Library (ITIL) standards. The presence of humans in the critical path for performing work introduces significant variability in the final outcome. Even if the nature of work is exactly the same, a human operator may execute it in a different way each time. For instance, he/she may use a different process or a different sequence of steps, or may be interrupted a number of times by external factors such as a telephone call or email. Enforcing and obtaining tight performance bounds in a human-staffed organization is far more difficult than in a process executed by a machine.

Generally, the competitive nature of IT service provider organizations has engendered a continuous improvement process, in that IT operators often aim to find ways to increase performance in terms of effectiveness, productivity and quality. One area of focus is in mashups, which are web applications created through the composition of preexisting web resources such as interactive maps, web services, traditional HTML pages, or even “Flash” presentations. Human performance issues can be critical here, as mashups usually involve an explicit objective of permitting users with limited or no programming skills to create their own tailored web applications whereas, by contrast, other traditional technologies usually demand from developers an enhanced level of technical knowledge and capability. To date, effective solutions for managing and making use of mashups in enhancing human performance have proven to be highly elusive.

### BRIEF SUMMARY

In summary, one aspect of the invention provides a method comprising: assimilating a process, the process comprising at least one step; estimating at least one quantitative metric with respect to the process; and determining at least one mashup pattern applicable to the process, the at least one mashup pattern comprising at least one mashup pattern applicable to at least one process step; the determining further comprising: recalculating the at least one quantitative metric in consideration of at least one mashup pattern; and applying at least one mashup pattern to the process responsive to improvement in the at least one quantitative metric.

Another aspect of the invention provides an apparatus comprising: at least one processor; and a computer readable storage medium having computer readable program code embodied therewith and executable by the at least one processor, the computer readable program code comprising: computer readable program code configured to assimilate a process, the process comprising at least one step; computer readable program code configured to estimate at least one quantitative metric with respect to the process; and computer readable program code configured to determine at least one mashup pattern applicable to the process, the at least one mashup pattern comprising at least one mashup pattern applicable to at least one process step, the determining comprising: recalculating the at least one quantitative metric in consideration of at least one mashup pattern; and applying at least one mashup pattern to the process responsive to improvement in the at least one quantitative metric.

An additional aspect of the invention provides a computer program product comprising: a computer readable storage medium having computer readable program code embodied therewith, the computer readable program code comprising: computer readable program code configured to assimilate a process, the process comprising at least one step; computer readable program code configured to estimate at least one quantitative metric with respect to the process; and computer readable program code configured to determine at least one mashup pattern applicable to the process, the at least one mashup pattern comprising at least one mashup pattern applicable to at least one process step, the determining comprising: recalculating the at least one quantitative metric in consideration of at least one mashup pattern; and applying at least one mashup pattern to the process responsive to improvement in the at least one quantitative metric.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 provides a table of task execution times.

FIG. 2 schematically illustrates an alerter mashup pattern.

FIG. 3 schematically illustrates an importer mashup pattern.

FIG. 4 schematically illustrates a transform mashup pattern.

FIG. 5 schematically illustrates a displayer mashup pattern.

FIG. 6 provides a table summarizing time reduction estimates for the patterns of FIGS. 2-5.

FIG. 7 schematically illustrates a case study of receiving and dispatching an e-ticket.

FIG. 8 schematically illustrates a workflow of activities performed by dispatchers at a service desk.

FIG. 9 schematically illustrates a procedure of relating mashup patterns with dispatching tasks.

FIG. 10 shows a Graphical User Interface (GUI) for a dispatching mashup.

FIG. 11 sets forth a process more generally for quantitatively modeling service processes.

FIG. 12 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

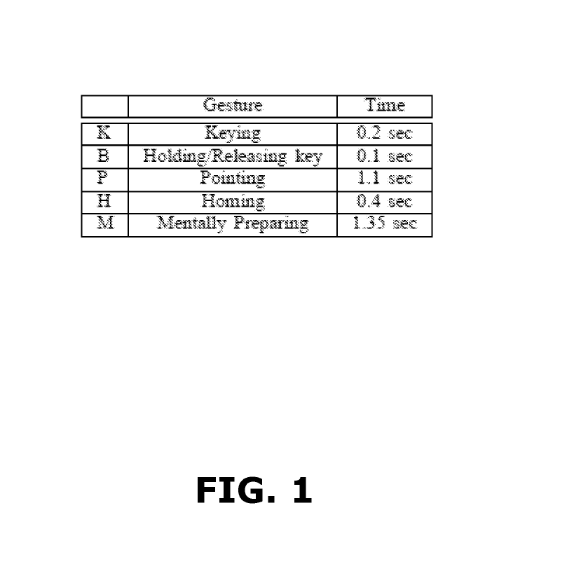

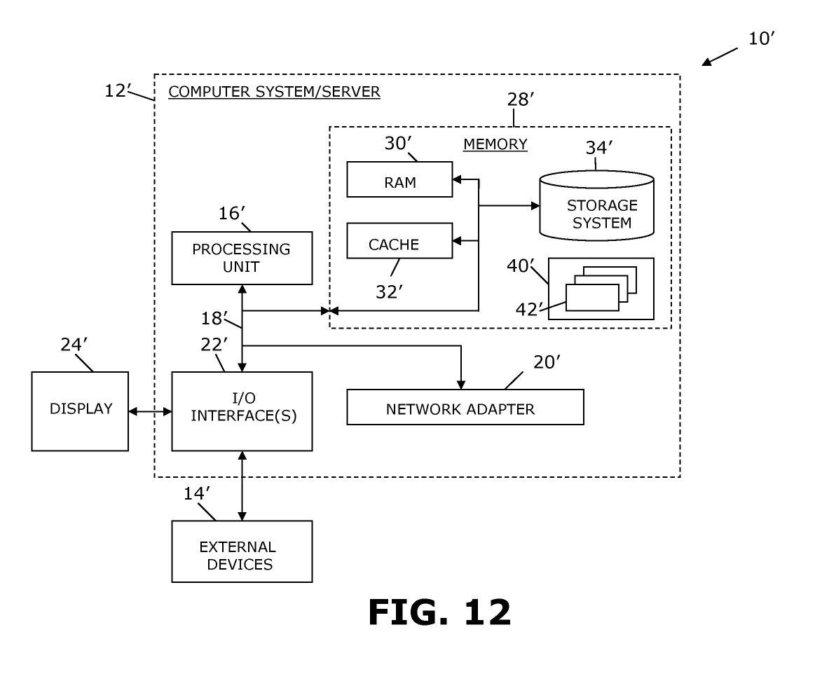

Specific reference will now be made herebelow to FIGS. 1-10. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12′ in FIG. 12. In accordance with an example embodiment, most if not all of the process steps, components and outputs discussed with respect to FIGS. 1-10 can be performed or utilized by way of a processing unit or units and system memory such as those indicated, respectively, at 16′ and 28′ in FIG. 12, whether on a server computer, a client computer, a node computer in a distributed network, or any combination thereof.

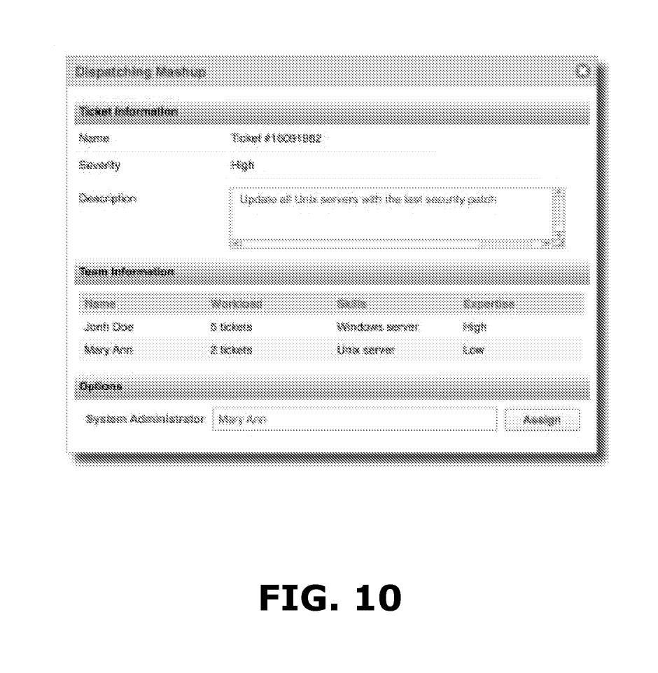

To facilitate easier reference, in advancing from FIG. 1 to and through FIG. 10, a reference numeral is advanced by a multiple of 100 in indicating a substantially similar or analogous component or element with respect to at least one component or element found in at least one earlier figure among FIGS. 1-10.

Broadly contemplated herein, in accordance with at least one embodiment of the invention, are models for evaluating and optimizing productivity in human-centered ITSM processes. Individual steps in the process are focused on that can be measured through instrumentation or observation, and can be improved through design and automation. In particular, a request fulfillment process is contemplated, which is one of several operational service management processes defined by ITIL. Also generally contemplated herein is a systematic framework for analyzing inefficiencies, and addressing them through a set of design patterns that ultimately provide a significantly improved orchestration of the process.

By way of background in connection with at least one embodiment of the invention, mashups can be quickly created, and present an additional benefit of being appropriate for composing situational applications, that is, applications that tackle very particular, short-lived problems and so would be otherwise expensive to be coded by specialized personnel. Mashups are generally composed through the use of basic operators which hide from mashup end users how the original web resources are orchestrated, so that users are exposed to the resulting mashup without being aware of the internal details of the composition. The coupling of such mashup operators can be guided in several ways. Using metadata available in the operator's definition, the mashup system engine can select default bindings between the operators that are being used during the composition step. Compatibility rules and quality criteria can be used to suggest the most appropriate operators for a given one.

In accordance with at context of at least one embodiment of the invention, several different categories of mashup basic operators can be considered. Visual operators deal with the visual presentation of relevant information through, for example, tables, graphs, and maps. Control operators relate to basic programming logics including loops and conditions. Transform operators manipulate data employing, for example, sorting and filtering. Adaptation operators translate original data from web resources into formats more easily handled inside mashups. Input operators allow end users to feed mashups with their particular information, for example, through text fields in web forms or by uploading files. Execute operators trigger the asynchronous background execution of actions without the explicit request of the end user, which is typical in background monitoring systems and similar applications. Reuse operators allow users to extend the available mashups to build more sophisticated compositions.

In accordance with a context of at least one embodiment of the invention, by using mashup basic operators, a user is able to specify mashups for a variety of different purposes. Where several problems share similar structure, however, it is often convenient to consider the employment of mashup patterns, where mashups with similar logic can be instantiated even more quickly from the same common pattern. In addition, because patterns enable previously proven mashups to be reused in new scenarios, mashup patterns provide an additional level of stability. Further below, a set of patterns will be defined to address inefficiencies discussed of types discussed herethroughout. Also presented further below is a quantitative evaluation of the potential impact of employing such patterns in ITSM using a combined model created based on the further-coming ones.

Generally, in accordance with further background and context in accordance with at least one embodiment of the invention, ITIL only provides high-level generic guidelines to IT organizations, without proposing, for example, concrete models and methods for capturing metrics and evaluating the quality of IT processes. Such evaluation can be very important for the IT service providers to quantify, measure, and most importantly to predict the deployment impact of IT solutions. Models, methodologies, and metrics have been proposed heretofore to fill this “gap”; two such models are presented herebelow.

By way of further background in connection with at least one embodiment of the invention, then, the Keystroke-Level Model (KLM) was previously proposed to predict the time an expert user takes to perform a given task on a given computer system (see, e.g., K. Card, A. Newell, and T. P. Moran, The Psychology of Human-Computer Interaction. Hillsdale, N.J., USA: L. Erlbaum Associates Inc., 2000.) Generally, the KLM model is based on a sequence of keystroke-level actions the user must perform to accomplish a task. This sequence is taken from a set of gestures, presented in the table shown in FIG. 1, where the total task execution time is the sum of the time for each of the gestures in the sequence. (For an overview of data such as that shown in FIG. 1, see, e.g.: S. K. Card, A. Newell, and T. P. Moran, The Psychology of Human-Computer Interaction. Hillsdale, N.J., USA: L. Erlbaum Associates Inc., 2000; and D. Kieras, “Using the keystroke-level model to estimate execution times,” University of Michigan, 2001.) The model also provides the average time for each gesture as presented below.

In accordance with a context of at least one embodiment of the invention, and as an example of the use of KLM to predict interaction time, a scenario of file deletion by a human operator can be considered. In this simple case, consider that the procedure is to drag the file icon to the trash can icon. For this, the action sequence can be represented as follows:
Initiate deletion (M).
Point to file icon (P).
Press and hold mouse button (B).
Drag file icon to trash can icon (P).
   The total interaction time, Tₜₒₜₐᵢ, can then be expressed as

Tₜₒₜₐₗ=2P+2B+M=2*1.1+2*0.1+1.35=3.75sec (1)

By way of additional background in connection with at least one embodiment of the invention, a “complexity model” represents yet another quantitative model. Conventionally, there have been contemplated methodologies for quantitative benchmarking of configuration complexity of an initial system setup. One approach (see, e.g., Y. Diao, A. Keller, S. S. Parekh, and V. V. Marinov, “Predicting labor cost through it management complexity metrics,” in In Proceedings of the 10th IFIP/IEEE Symposium on Integrated Management, 2007, pp. 274-283) can be summarized in three steps: assessing the complexity and timing a baseline scenario, construction of the regression model and evaluation of the model quality, and finally employing the model to predict labor costs, such as time. The relationship between time and complexity metrics are investigated using a multiple linear regression technique, with an equation as presented below:

y=β₀+β₁x₁+β₂x₂+ . . . +βₙxₙ (2)

In the above equation, the xᵢ represent the IT management complexity metrics, and the least squares approach is employed to discover the βᵢ value.

In accordance with at least one embodiment of the invention, it can be recognized that inefficiencies represent portions of a service management process characterized by suboptimal execution of activities. Considered herein are inefficiencies characterized as segments of the process where suboptimal human productivity reduces overall throughput for the process. There can be recognized higher level inefficiencies attributable to the complexity of the activity itself, and lower level inefficiencies attributable to the mechanical execution involved in performing the activity. Additionally, four general categories of inefficiencies can be recognized: basic, information management, skill-dependent, and synchronization. “Basic” refers to the most simple and low-level inefficiencies, occurring independently from the others. “Information-management” inefficiencies are formed by the combination of several basic inefficiencies. “Skill-dependent” inefficiencies relate to the reasoning capabilities or training of the human operator. Finally, “synchronization” inefficiencies are those incurring delays due to factors such as waiting for an external input. Generally, it can be noted that synchronization, information-management and skill-dependent inefficiencies typically include both high-level and low-level components. For example, converting a time from one time zone to another can represent “information management”, and thus include inefficiencies that are both low-level (e.g., reading and typing times) and high-level (e.g., figuring out the appropriate time zone and doing the calculation).

In accordance with at least one embodiment of the invention, aspects of the KLM and complexity models discussed hereinabove are combined. Accordingly, an analyst may construct a combined model by way of the following stages: work with a domain expert to determine the tasks and subtasks of the process; work with a domain expert to determine complexity metrics for the complexity model; determine the KLM model through observation of user interactions; measure the time to perform each of several subtasks; derives the complexity model coefficients from the time measurements (e.g., by employing a method such as that discussed in L. Shwartz, Y. Diao, and G. Grabarnik, “Multi-tenant solution for it service management: A quantitative study of benefits,” in Integrated Network Management, 2009, pp. 721-731); and thence, since β₀ of Equation (2) represents the expected time for all factors not explained by the complexity model, the time predicted by the KLM model can be subtracted from β₀.

As such, in accordance with at least one embodiment of the invention, a combined model permits a prediction of the expected change in time due to modifications in the process. A standardized set of modification templates can be created, with the potential to search through them to find an optimally modified process, along with the expected time savings. A particular set of modification templates can apply specifically to subtasks involving interactions with a user interface in processing information. These templates, or mashup patterns, can then form building blocks for quantitatively motivated process improvement in human-computer interactions within ITSM.

In accordance with at least one embodiment of the invention, mashup patterns, such as those described herebelow by way of illustrative and non-restrictive example, can be used to address inefficiencies in ITSM (or other) scenarios. They are context-independent and can address different scenarios. For each proposed mashup pattern, a relevant ITSM problem is discussed by way of example, along with an associated solution that can employ the pattern.

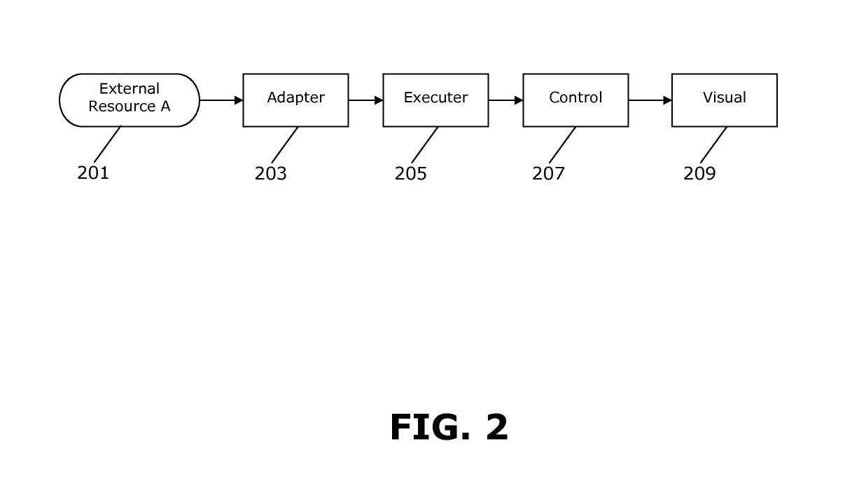

In accordance with at least one embodiment of the invention, FIG. 2 schematically illustrates an alerter pattern. By way of a sample problem, in ITSM, it is common to find scenarios where a user needs to be aware of events in the managed environment. The simplest method to support this involves periodically accessing the management system to manually look for new events. For example, in the service dispatching scenario, service tickets are created at no specific time, and a dispatcher responsible for assigning those tickets needs to constantly access the ticketing system to check for new requests. That can become a problem if the dispatcher does not access the system sufficiently often, or if the time spent in unnecessary repeated accesses degrades the dispatcher's productivity. It can be even worse when the amount of monitored information is very large, or when the dispatcher needs to promptly react to time-sensitive events.

By way of a solution in accordance with the example of FIG. 2, the mashup alerter pattern periodically monitors a system of interest on behalf of the user and, based on previously established conditions, sends notifications only when events of interest take place. For example, alerts can take the form of visual elements on the user's console, e-mail messages, or SMS (text) messages. Another advantage of using an alerter mashup pattern relates to situations where multiple systems must be monitored at the same time, eventually overloading the human operator with too much information. In that case, correlated events from different systems can be summarized to decrease the number of notifications. External resource A (201) refers to a source of an alert, such as a temperature gauge or monitoring software. The basic mashup operators employed here are adapter 203, executer 205, control 207 and visual 209. Adapter 203 converts the data into a format usable by the rest of the operators. Executer 205 allow the mashup to initiate events, such as opening windows or interrupting normal tasks. Control 207 allows data to be restricted by filters and adjustable thresholds, etc. Visual operator 209 permits the display of data to a user. It should be noted that operators (e.g., operators 203-209) may require configuration as part of the instantiation process; thus, e.g., while control 207 permits filtering or thresholding, any and all specific filters and thresholds might not actually represent part of that operator.

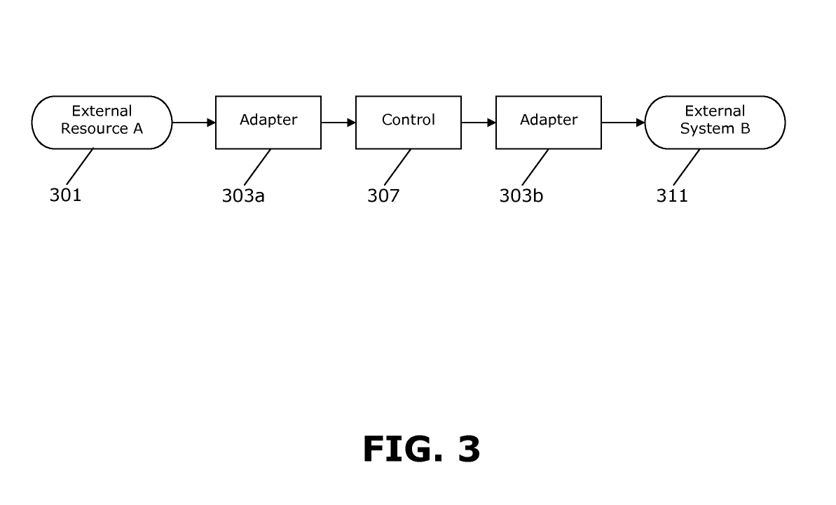

In accordance with at least one embodiment of the invention, an adapter operator such as that indicated at 203 (as well as other adapter operators described and illustrated with respect to FIGS. 3-5) can represent external resources accessed by the system, and thus can be responsible for both retrieving and translating external data. Generally, they can represent existing wrappers, which themselves act as gateways to different access methods and data formats. When a mashup is executed, each relevant wrapper for the mashup can start, retrieve external data, translate it, and forward it to elements which will integrate the retrieved data and build an item (e.g., a Web page) presenting the composition result.

In accordance with at least one embodiment of the invention, FIG. 3 schematically illustrates an importer pattern. By way of a sample problem, in ITSM, it is not uncommon to find scenarios where customers and service providers require the use of common data, although they use their own, particular database systems. To maintain data consistency across such systems, diverse methods can be used. For example, data adapters can grant one party access to the system of another's. When adapters are not available, screen scrapers can be used to access the Web interface of the remote system and retrieve the common data. Finally, users can access one another's systems and manually copy and paste the common data into their own system's interface. In all these cases, maintaining data consistency is not transparent for the users because they need to consciously switch the integration method when accessing multiple systems.

By way of a solution in accordance with the example of FIG. 3, it can be noted that if external resources natively expose an application programming interface (API), then leveraging their information is just a matter of basic software programming. However, it is often the case that the most valuable content is locked away in closed or proprietary formats. In these cases, an importer mashup pattern such as that in FIG. 3 abstracts the different methods used to access the external data so that data consistency maintenance becomes transparent to the user. Here, external resource A and external system B (301 and 311, respectively), can represent a customer's and a service provider's databases, respectively. The basic mashup operators employed here are first adapter 303a, control 307, and second adapter 303b. Here, first adapter 303a converts the data feed from the format provided by resource (A) 301 to an internal format usable by the control 307 and the second adapter 303b. The control 307, for its part, provides a point of control, such as a point where the data flow can be shut off, and possibly can undertake other filtering as well. Here, control 307 represents an optional operator that need not necessarily be included. The second adapter 303b converts the internal data format to one acceptable to system B (311).

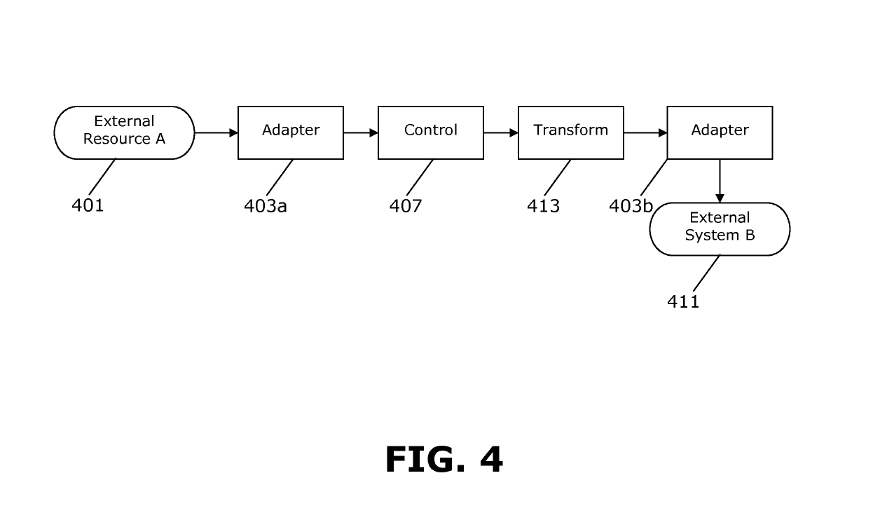

In accordance with at least one embodiment of the invention, FIG. 4 schematically illustrates a transform pattern. By way of a sample problem, while interacting with different systems, it is common to find cases where data needs to undergo some simple processing while being transferred from one screen to another. For example, while copying a field, a user needs to apply rules to filter out confidential information, or the data needs to be reformatted before it could be used by a different system (e.g., US and UK date formats). These data transformations are usually manually performed because ITSM systems are often created without having integration in mind.

By way of a solution in accordance with the example of FIG. 4, during the process of importing data, transform operators can be inserted into the mashup logic to enable the processing of certain types of data and thus both materializing the compatibility between systems and satisfying the requirements of the IT process. It is thus possible to reduce the number of manual interventions performed by the human through the automation of these adaptations. The basic mashup operators employed here are adapter 403a, control 407, transform 413 and adapter 403b. Adapters 403a/b and control 407 can function similarly as with respect to other example of FIG. 3 (and, likewise, control 407 can be considered an optional component). Transform operator 413 changes data (and not just formats. For example, it can convert from one unit to another. In this case, the data is adapted to the internal format, possibly filtered using the control 407, transformed as desired, and adapted to a format acceptable by system B (411).

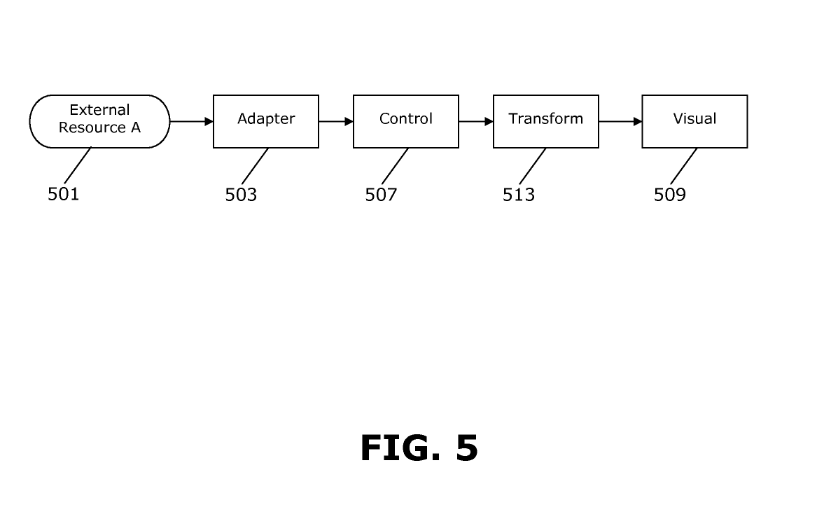

In accordance with at least one embodiment of the invention, FIG. 5 schematically illustrates a displayer pattern. By way of a sample problem, it can be noted that in order to make better decisions, humans involved in ITSM activities use information from multiple systems. This information is often memorized or recorded for future use during the decision making process. For example, a configuration database process can automatically generate a port number that needs to be remembered when installing another application. If the port number is forgotten or misremembered, errors in the process may occur.

By way of a solution in accordance with the example of FIG. 5, it can be noted that mashups combine data from multiple sources and present the results of this combination in a Web page. However, this integration tends to occur only at the presentation level; it rarely occurs at the data level. This means that information from multiple systems can be presented alone in the same Web page as independent widgets. The employment of many displayer patterns in one page enforces the concept of a “single pane of glass”. This concept reduces the risks of having a poorly executed process, which would generate errors and impose costs to the company. The basic mashup operators employed here are adapter 503, control 507, transform 513 and visual 509, and can perform similarly to analogous operators illustrated and discussed with respect to FIG. 204. Control 507 and transform 513 can be optional components here, such that, in sum, the data is adapted to the internal format (via adapter 503), optionally controlled (via control 507), optionally transformed (via transform 513), and displayed to a human user (via visual operator 509).

In accordance with at least one embodiment of the invention, it can now be appreciated that the methodology of a “combined model”, as described hereinabove, permits an estimation of time savings for mashup patterns. In this manner, users can predict performance improvements quantitatively before deploying mashups over their current ITSM processes. A scenario involving an alerter mashup pattern (FIG. 2) can be considered here by way of an illustrative and non-restrictive example.

In accordance with an illustrative example, in accordance with at least one embodiment of the invention, it can be appreciated that the scenario described hereinabove with respect to the alerter pattern of FIG. 2 is a task composed of several subtasks. The first subtask is for the operator to notice that it is time to check for new events. The time spent “becoming aware” of the need to start the task can be indicated as Tₐ. Once the operator decides to look for new requests, the next subtask is to interact with tools to examine the new events. The time spent on this subtask, which can be modeled by KLM, can be labeled as Tₖ. If all requests are considered to be processed independently of the others. the alerter pattern of FIG. 2 can decrease time spent on a task by reducing the awareness time Tₐ to zero. Once requests arise, notifications can be sent to the human operator automatically. In addition, a well-designed implementation of the alerter pattern could reduce Tₖ, for example by allowing the dispatcher to access the ticket associated with an alert with just one mouse click.

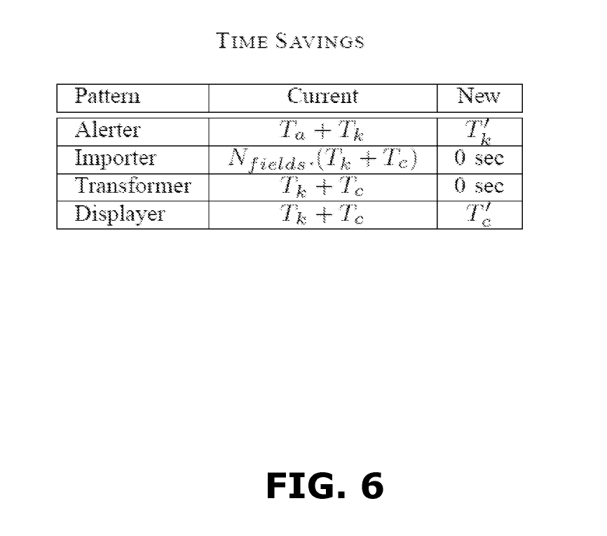

In accordance with at least one embodiment of the invention, it can be noted that scenarios where the importer and transformer patterns can be applied (FIGS. 3 and 4, respectively) present two types of inefficiencies: mechanical execution (Tₖ) and task complexity (Tₐ). Since both operations can be completely automated by employing mashup patterns, the time reduction in those scenarios is 100%. The same applies to the displayer pattern (FIG. 5). Since the necessary information to process a request is provided in one single screen to the human operator, the time spent looking for the information is decreased to zero and the time associated with complexity is significantly decreased due to eliminating the need to remember one specific piece of information. FIG. 6 presents a table which summarizes a time reduction estimation for each of the patterns presented in FIGS. 2-5 (alerter, importer, transformer, displayer, respectively), where the column “Current” refers to the current task duration and “New” refers to the reduced task duration. The variable “N_{fields}”, for its part, refers to the number of data fields in each record being imported.

In accordance with at least one embodiment of the invention, the disclosure now turns to a case study of the application of a quantitative methodology, as broadly contemplated herein, to an existing ITSM activity. As such, a request fulfillment process can be considered as one of the operational processes in IT management. Generally, request fulfillment is a process that deals with service requests.

In accordance with the present illustrative example, in accordance with at least one embodiment of the invention, it can be noted that Request Fulfillment interfaces primarily with Service Desk and Incident Management, and supports two functions: it provides a point of communication for users and serves as a point of coordination between several groups and activities. The latter function of Request Fulfillment is considered here. The process for this case study breaks coordination into two main activities: support the requests made by the customers, and solve those requests. Requests are solved by system administrators (SAs) with technical knowledge to resolve specific requests. Requests are supported by human operators, called dispatchers, with responsibilities that include: monitoring for new requests, dispatching the requests to the appropriate SA, and monitoring compliance with Service Level Agreements (SLAs).

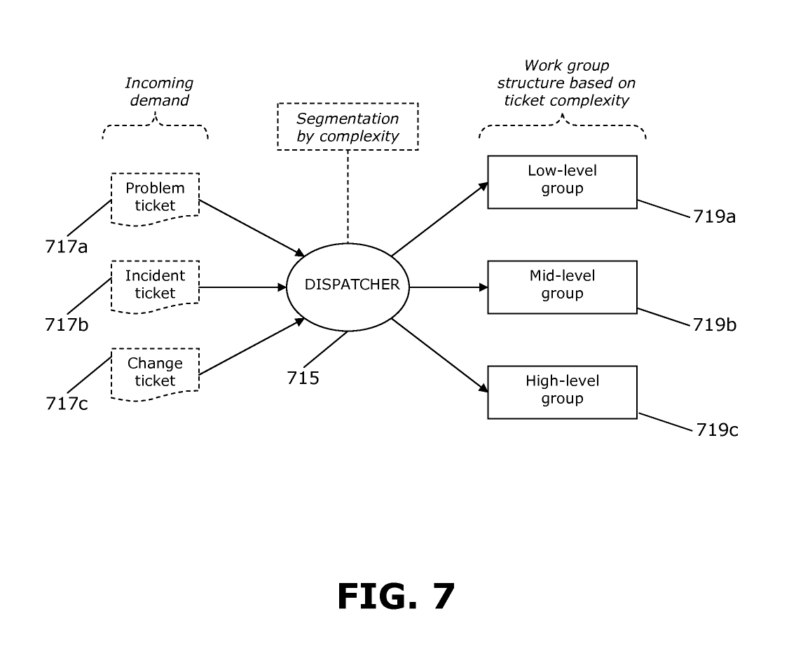

In accordance with the present illustrative example, in accordance with at least one embodiment of the invention, and as shown schematically in FIG. 7, a case can be considered where a dispatcher 715 has knowledge of standard fulfillment procedures and responsibility for generating requests and assigning them to an SA. The Service Desk receives requests and creates a ticket, which may be any of the following types: problems (717a), incidents (717b), changes (717c). Tickets 717a-c are routed to dispatcher 715, who is responsible for analyzing the request and determining the appropriate SA to assign it to for a resolution, wherein the SA is understood to have the required skills and knowledge to solve specific requests and is responsible for taking the appropriate actions and closing the ticket. Thus, for instance, a ticket could be forwarded to an SA in any of a number of broad skill-level groups such as: a low-level group 719a for simpler tickets; a mid-level group 719b for somewhat more complex problems such as root cause analysis; and a high-level group 719c for the highest-complexity tickets.

In accordance with the present illustrative example, in accordance with at least one embodiment of the invention, usually, a dispatcher 715 is responsible for a team of system administrators in a specialized technical background. Customers create new requests (i.e., tickets 717a-c) in Service Desk systems, and include all information used by SA's (719a-c) to solve the request. Once the dispatcher 715 receives the ticket and determines that his/her team can resolve the ticket, he/she would use his knowledge of his/her team's schedules and workloads as well as the expertise of each system administrator to finally make the assignment.

In accordance with the present illustrative example, in accordance with at least one embodiment of the invention, it can be noted that several time-consuming issues can arise in the dispatching process, making it infeasible to resolve tickets within the times established in SLAs and therefore resulting in financial loss to service providers. For example, it is common for customers and service providers to use their own ticketing systems, making it necessary to import data and maintain consistency between the systems. Dispatchers need to deal with data consistency and redundancy without violating any customer policies, such as data compliance for dealing with confidential information. In addition, the dispatcher and his/her team of SAs may be responsible for multiple customers, where each customer has a different ticketing system. This adds additional overhead in switching between multiple systems. Finally, information required for finding the most appropriate SA for one specific ticket could reside in various locations and require different tools to access it. For example, schedules tend to be managed by calendar-based systems, while the SA's actual workloads would be most accurately represented in Request Fulfillment systems and finally it is common to have SA skills associated with their user profile in the service provider's directory.

In accordance with the present illustrative example, in accordance with at least one embodiment of the invention, it can be noted that automated dispatching solutions may be complex due to the variability of the environment and therefore it is not always feasible or the best alternative for this scenario. For example, in some situations a dispatcher may want to train a new administrator, and so may intentionally assign a request to a less skilled SA than is available. In this context, mashups can advantageously permit the creation of dispatching systems to focus on the process of each dispatcher and helping him/her improve the efficiency of the assignment.

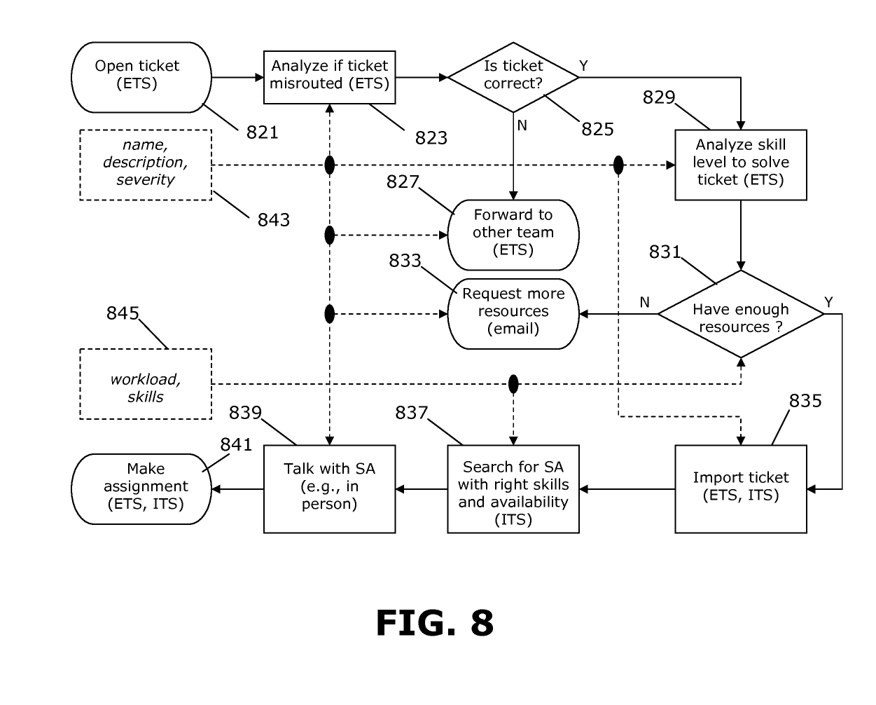

As such, in accordance with the present illustrative example, in accordance with at least one embodiment of the invention, in order to discover bottlenecks in the dispatch process, experimentation was performed via a series of time measurements among four dispatchers in a service delivery center. Using a stopwatch, 10 measurements were taken for each assignment process and its individual tasks. This process is represented in FIG. 8 as a workflow, which was obtained following the “combined model” methodology discussed hereinabove.

In accordance with the present illustrative example, in accordance with at least one embodiment of the invention, the process shown in FIG. 8 includes the following steps. After opening a ticket via an external ticketing system (ETS) (821), an analysis is made as to whether the ticket is misrouted (823). If (825) the ticket is not correct, then it is forwarded to another team (827). Otherwise, an analysis is made as to the skill level needed to solve the ticket (829). If (831) enough resources are not available, more are requested (833). Otherwise, the ticket is imported (835), at which point an internal ticketing system (ITS) is involved. A search is made for a SA with the proper skills and availability (837), and the SA is then communicated with (e.g., talked to over the telephone or in person) (839). The ticket is then assigned to the SA in question (841).

In accordance with the present illustrative example, in accordance with at least one embodiment of the invention, information on a ticket serves as an input 843 to steps 823, 827, 829, 833, 835 and 839 of the process. Such information can include a name or label for the ticket, a description thereof, and an indication of its severity. On the other hand, information on an SA serves as an input 845 to steps 831 and 837. Such information can include an SA's current workload as well as his/her skill set.

In accordance with the present illustrative example, in accordance with at least one embodiment of the invention, results of the aforementioned measurements showed a significant time variation according to the ticket's complexity and the dispatcher's familiarity with the reported issue. For simple tickets (TS), usually repetitive tasks that the dispatcher is accustomed to assigning, the time average was 159 seconds (90% confidence level, 23.65 standard deviation), while for high complexity tickets (TC) this time was 357 seconds (90% confidence interval, 41.58 standard deviation). This difference can be justified by the need to spend more time reasoning about all the information related to the ticket, and also by the need to gather and provide detailed information to the system administrators.

In accordance with the present illustrative example, in accordance with at least one embodiment of the invention, looking at the individual tasks, 35 (TS) and 58 (TC) seconds of the time were spent analyzing whether the ticket was misrouted or not. To accomplish this task, dispatchers need to look for the right information (e.g., keywords on a ticket description) and decide if their teams have the right knowledge to solve the ticket. It was also observed that most of the time was spent manually importing the tickets. This task consumed 41% and 50% of the time, respectively, for simple and complex tickets. Finally, 58 (TS) and 94 (TC) seconds of the time were spent making the assignment, an activity which involves updating the SA assignment information in both ITS's and ETS's.

In accordance with the present illustrative example, in accordance with at least one embodiment of the invention, all the proposed patterns can be used to create a mashup-based solution for the above-mentioned dispatching scenario. By using them, a dispatcher's assignment performance can be improved by automating some tasks, and by implementing the “single pane of glass” concept. This concept, essentially, relates to having all the necessary information a human operator may need to achieve a goal presented in a single screen with the data already filtered and transformed.

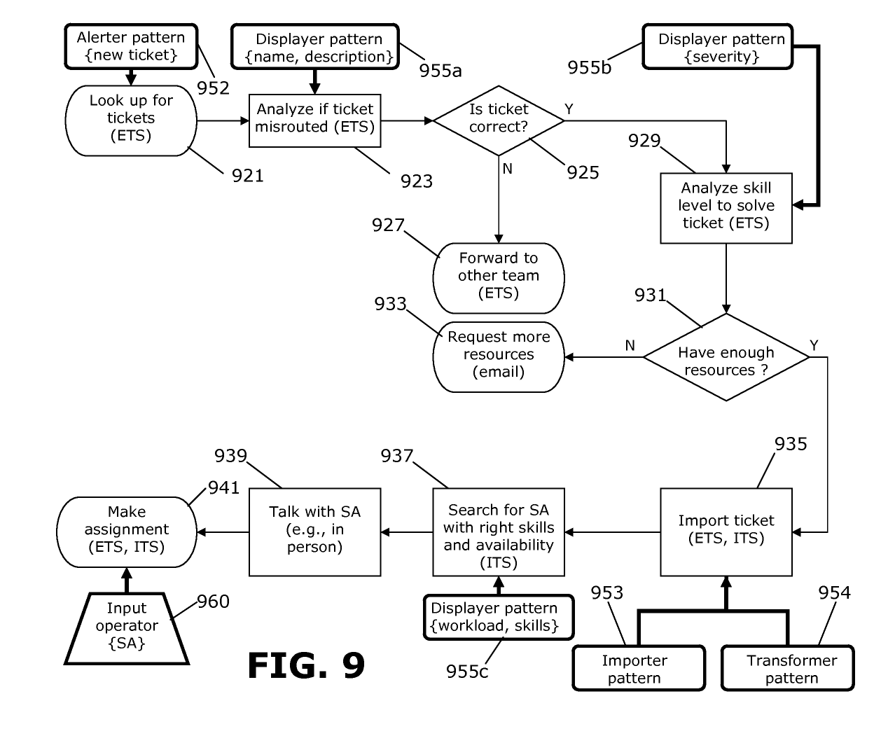

In accordance with the present illustrative example, in accordance with at least one embodiment of the invention, FIG. 9 shows how mashup patterns such as those illustrated in FIGS. 2-5 can relate to dispatching tasks. Considering that name, description, and severity are the basic information from a ticket that a dispatcher uses most frequently to make the assignments, a displayer pattern 955a/b/c can be used to show all the needed information in a single screen. This pattern can also be used to display the system administrator's workload and skills. With this pattern, it is possible to eliminate in this task inefficiencies both of information lookup and of retaining information. As such, a first displayer pattern 955a can be employed in step 923, showing a name and description of a ticket. A second displayer pattern 955b can be employed in step 929, showing ticket severity. Further, a third displayer pattern 955c can be employed in step 937, showing workload and skills of an SA.

In accordance with the present illustrative example, in accordance with at least one embodiment of the invention, since dispatchers typically need to constantly monitor for new tickets, an alerter pattern 952 can be used to notify them about new tickets as soon as they are created, and eliminate the aforementioned “becoming aware” inefficiency; this can be employed in step 921. An importer pattern 953 can be used to automate the task of importing tickets to the internal database, and a transformer pattern 954 can be applied when the dispatchers need to modify (e.g., augment or exclude) some information, for example, filtering confidential data (e.g., phone numbers) on the ticket's description. Both (953/954) can be employed in step 935.

In accordance with the present illustrative example, in accordance with at least one embodiment of the invention, an input operator 960 can be employed in step 941 to permit a dispatcher to specify a SA to be responsible for solving a ticket. FIG. 10 shows a Graphical User Interface (GUI) for the dispatching mashup, constructed based on mashup patterns, and representing a culmination of the assembled mashup patterns from FIG. 9. Inasmuch as mashup patterns are composed of basic operators, of which an input operator 960 (FIG. 9) can represent one of these.

In accordance with at least one embodiment of the invention, while a focus as set forth hereinabove has related to modeling and predicting efficiency gains by using the mashups, it is to be noted that there are also a wide variety of possibilities for effecting mechanics of instantiating the mashups. For instance, a step may be undertaken of ranking prospective mashup patterns against one another, and then choosing from among them. Ranking can be based on any of a wide variety of possible metrics which may include calculated or estimated time savings of different mashup patterns with respect to one another e.g., using metrics, and combinations thereof, such as those described and illustrated with respect to FIG. 6. Thus, mashup patterns comprising “building blocks” of different adapter, executer, control, visual and transform mashups can be quantitatively assessed based on a metric such as estimated time savings and then compared against one another. Different mashups within each category of operators (e.g., adapter, executer, etc.) can be considered in such a determination such that a wide range of prospective mashup patterns can be conceptually assembled and then chosen from.

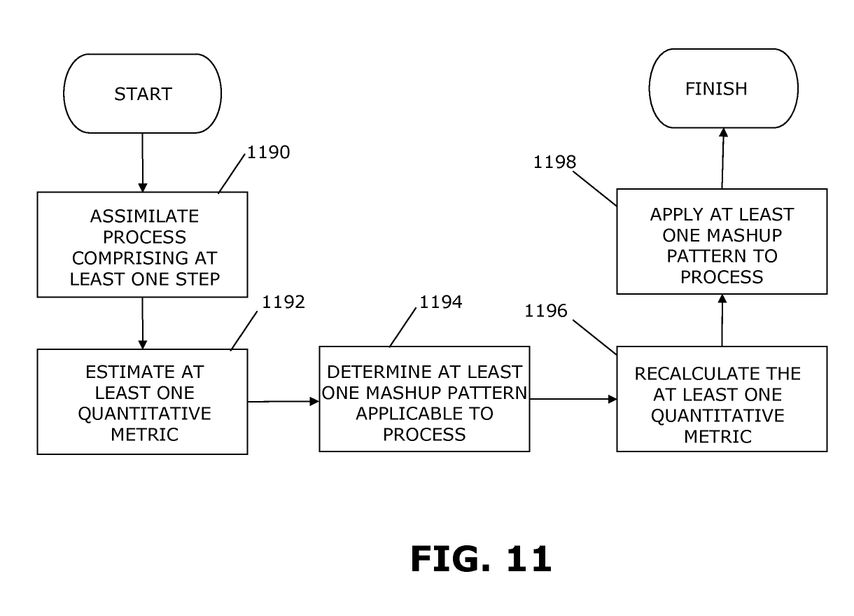

FIG. 11 sets forth a process more generally for quantitatively modeling service processes, in accordance with at least one embodiment of the invention. It should be appreciated that a process such as that broadly illustrated in FIG. 11 can be carried out on essentially any suitable computer system or set of computer systems, which may, by way of an illustrative and on-restrictive example, include a system such as that indicated at 12′ in FIG. 12 In accordance with an example embodiment, most if not all of the process steps discussed with respect to FIG. 11 can be performed by way a processing unit or units and system memory such as those indicated, respectively, at 16′ and 28′ in FIG. 12.

As shown in FIG. 11, in accordance with at least one embodiment of the invention, a process is assimilated, the process comprising at least one step (1190). At least one quantitative metric with respect to the process is estimated (1192), and at least one mashup pattern applicable to the process is determined, the at least one mashup pattern comprising at least one mashup pattern applicable to at least one process step (1194). The determining includes recalculating the at least one quantitative metric in consideration of at least one mashup pattern (1196) and applying at least one mashup pattern to the process responsive to improvement in the at least one quantitative metric (1198).

Referring now to FIG. 12, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that is accessible by computer system/server 12′, and it includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ by way of example, and not limitation, as well as an operating system, at least one application program, other program modules, and program data. Each of the operating system, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enable a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples, include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating a process, the process comprising at least one step;
estimating at least one quantitative metric with respect to the process; and
determining at least one mashup pattern applicable to the process, the at least one mashup pattern comprising at least one mashup pattern applicable to at least one process step;
said determining further comprising:
recalculating the at least one quantitative metric in consideration of at least one mashup pattern; and
applying at least one mashup pattern to the process responsive to improvement in the at least one quantitative metric.

2. The method according to claim 1, wherein the assimilated process comprises at least one manual step.

3. The method according to claim 2, wherein the assimilated process comprises at least two manual steps.

4. The method according to claim 1, wherein said estimating comprises estimating at least one quantitative metric with respect to each process step;

5. The method according to claim 1, wherein said determining comprises determining a mashup pattern applicable to each of at least one process step.

6. The method according to claim 1, wherein the at least one quantitative metric comprises an efficiency metric.

7. The method according to claim 1, wherein at least one determined mashup pattern comprises at least one mashup operator.

8. The method according to claim 7, wherein the at least one mashup operator comprises at least one taken from the group consisting of: an adapter operator, an executer operator, a control operator, a visual operator, a transform operator.

9. The method according to claim 1, wherein at least one determined mashup pattern is taken from the group consisting of: an alerter pattern, an importer pattern, a transform pattern, a displayer pattern.

10. The method according to claim 9, wherein:
the alerter pattern comprises an adapter operator, an executer operator, a control operator and a visual operator;
the importer pattern comprises two adapter operators and an optional control operator;
the transform pattern comprises two adapter operators, an optional control operator and a transform operator; and
the displayer pattern comprises an adapter operator, an optional control operator, an optional transform operator and a visual operator.

11. The method according to claim 1, wherein the process is a service management dispatch process.

12. An apparatus comprising:
at least one processor; and
a computer readable storage medium having computer readable program code embodied therewith and executable by the at least one processor, the computer readable program code comprising:
computer readable program code configured to assimilate a process, the process comprising at least one step;
computer readable program code configured to estimate at least one quantitative metric with respect to the process; and
computer readable program code configured to determine at least one mashup pattern applicable to the process, the at least one mashup pattern comprising at least one mashup pattern applicable to at least one process step, the determining comprising:
recalculating the at least one quantitative metric in consideration of at least one mashup pattern; and
applying at least one mashup pattern to the process responsive to improvement in the at least one quantitative metric.

13. A computer program product comprising:
a computer readable storage medium having computer readable program code embodied therewith, the computer readable program code comprising:
computer readable program code configured to assimilate a process, the process comprising at least one step;
computer readable program code configured to estimate at least one quantitative metric with respect to the process; and
computer readable program code configured to determine at least one mashup pattern applicable to the process, the at least one mashup pattern comprising at least one mashup pattern applicable to at least one process step, the determining comprising:
recalculating the at least one quantitative metric in consideration of at least one mashup pattern; and
applying at least one mashup pattern to the process responsive to improvement in the at least one quantitative metric.

14. The computer program product according to claim 13, wherein the assimilated process comprises at least one manual step.

15. The computer program product according to claim 13, wherein said computer readable program code is configured to estimate at least one quantitative metric with respect to each process step;

16. The computer program product according to claim 13, wherein said computer readable program code is configured to determine a mashup pattern applicable to each of at least one process step.

17. The computer program product according to claim 13, wherein the at least one quantitative metric comprises an efficiency metric.

18. The computer program product according to claim 13, wherein at least one determined mashup pattern comprises at least one mashup operator.

19. The computer program product according to claim 18, wherein the at least one mashup operator comprises at least one taken from the group consisting of: an adapter operator, an executer operator, a control operator, a visual operator, a transform operator.

20. The computer program product according to claim 13, wherein at least one determined mashup pattern is taken from the group consisting of: an alerter pattern, an importer pattern, a transform pattern, a displayer pattern.
